(19) United States
(12) Patent Application Publication
(10) Pub. No.: US 2021/0138412 A1
(43) Pub. Date: May 13, 2021

(54) Acid Skid

(71) Applicant: Seth Ren Sawyer, Iraan, TX (US)

(72) Inventor: Seth Ren Sawyer, Iraan, TX (US)

(21) Appl. No.: 17/093,480

(22) Filed: Nov. 9, 2020

Related U.S. Application Data
(60) Provisional application No. 62/932,502, filed on Nov. 8, 2019.
(60) Provisional application No. 62/932,496, filed on Nov. 7, 2019.

(51) Int. Cl. B01F 5/10; B01F 5/12

(52) U.S. Cl. CPC B01F 5/106; B01F 5/12; F17C 13/083; F17C 2227/0135; F17C 2270/0171

(57) ABSTRACT

A multiple tank acid mixing and delivery system for receiving and managing a plurality of fluids and mixing a final acid mixture for use in hydraulic fracturing process. The multiple tank acid mixing and delivery system comprises a support frame, a mix tank, an acid tank, a plumbing system, a control system, and a water manifold, a main connection manifold.

### CROSS-REFERENCE TO RELATED APPLICATIONS

This application claims benefit to U.S. Patent Application No. 62/932,502, filed on Nov. 8, 2019.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant.

The hydraulic fracturing process has allowed the oil industry to extract oil in tight shales plays worldwide. We are now drilling laterals up to 3 miles and completing frac stages every 200-300 ft. along that lateral. Sand is being pumped into this rock at high pressure which fractures the rock, releasing oil that has been trapped in the rock matrix. At each stage we are pumping 300,000-600,000 lbs. of sand. Before we can establish the proper pumping rate, acid spearhead is pumped in front of water to break down the perforations in each stage. Each stage will have 1500-4000 gallons of hydrochloric acid pumped by the pressure pumping company. The industry has typically used steel acid tanks which have been coated inside to hold this mixture of acid, such as a prior art acid tank skid 100 illustrated and discussed below.

### BRIEF SUMMARY OF THE INVENTION

A multiple tank acid mixing and delivery system for receiving and managing a plurality of fluids and mixing a final acid mixture for use in hydraulic fracturing process. Said multiple tank acid mixing and delivery system comprises a support frame, a mix tank, an acid tank, a plumbing system, a control system, and a water manifold, a main connection manifold.

### BRIEF DESCRIPTION OF THE SEVERAL VIEWS OF THE DRAWING

FIGS. 1A, and 1B illustrate a perspective overview and an elevated top view of a prior art acid tank skid 100.

FIG. 2 illustrates an elevated top view of a multiple tank acid mixing and delivery system 200.

FIG. 3 illustrates a perspective overview of said multiple tank acid mixing and delivery system 200.

FIG. 4 illustrates perspective rear view of said multiple tank acid mixing and delivery system 200.

FIG. 5 illustrates a perspective overview of a mix tank 204.

FIG. 6 illustrates a perspective overview of said mix tank 204.

FIG. 7 illustrates an elevated side view of said mix tank 204 with a cutaway on a support frame 202.

FIG. 8 illustrates a perspective overview of a central portion 318 of said multiple tank acid mixing and delivery system 200 with said mix tank 204 and a plumbing system 208.

FIGS. 9A, and 9B illustrate an elevated top view and detailed view of said multiple tank acid mixing and delivery system 200 without said mix tank 204 and an acid tank 206.

FIG. 10 illustrates an elevated side view of said acid tank 206.

FIG. 11 illustrates a perspective overview of a rear end 308 of said support frame 202.

FIGS. 12A, and 12B illustrate a perspective overview and lower side view of said multiple tank acid mixing and delivery system 200.

FIG. 13 illustrates a perspective detailed view of A call out A 1200.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

FIGS. 1A, and 1B illustrate a perspective overview and an elevated top view of a prior art acid tank skid 100.

Said prior art acid tank skid 100 can comprise a single liquid tank 102, and a manifold 104. Said prior art acid tank skid 100 can comprise one component required to create a final acid mixture 106 from a water 108, a high concentration acid 110, a corrosion inhibitor 112 and a various chemicals 114. Fluids 106-114 are discussed but not illustrated.

In one embodiment, said prior art acid tank skid 100 holds about 20000 gallons (+/−480 bbls) in said single liquid tank 102. On these frac jobs operators bring said high concentration acid 110 to the location which is about 32% HCL. Operators can dilute the acid by adding said water 108 to these tanks and then add the 32% HCL to the water to bring the concentration typically down to 15%. During each dilution, it is desirable that said final acid mixture 106 must have a certain concentration of said corrosion inhibitor 112 and said various chemicals 114 added to said final acid mixture 106.

Among other drawbacks, said prior art acid tank skid 100 requires a fluid pump 116 must be connected to said single liquid tank 102 and circulate said final acid mixture 106 to disperse said various chemicals 114 and properly mix said final acid mixture 106.

If said final acid mixture 106 is not mixed, said final acid mixture 106 will sink to the bottom of said single liquid tank 102 since acid is heavier than water. Therefore, if the tank sits very long, an operator or pumping company will have to mix said final acid mixture 106 again to get proper mixture and concentration.

Additionally, said single liquid tank 102 of said prior art acid tank skid 100 are not typically acid approved containers, but are used nonetheless because operators need to pump said final acid mixture 106 out of these said single liquid tank 102 at high rate.

Further problems with said prior art acid tank skid 100 include issues regarding chemistry and material choices. Said high concentration acid 110 can comprise a hydrochloric acid which is highly corrosive to metal. Even though said single liquid tank 102 can be epoxy coated, any ding or scratch to the coating will accelerate metal corrosion. Constant maintenance is required to keep these tanks in top form.

Likewise, said manifold 104 in front of said single liquid tank 102 is also made of steel and will experience acid corrosion on the valves and connections. Operators have had acid spills due this corrosion and have lost a whole tank of acid on the ground. This is very dangerous.

FIG. 2 illustrates an elevated top view of a multiple tank acid mixing and delivery system 200.

In one embodiment, said multiple tank acid mixing and delivery system 200 can comprise a support frame 202, a mix tank 204, an acid tank 206, a plumbing system 208, a control system 210, a cone tank 212, a chem tote input 214, a chemical tote platform 216, an acid fill line 218, a first pump 220, a water line 222, a motor control station 224, a mix tank discharge valve 226, a water manifold 228, a main connection manifold 230, a trailer wheels 232, and a trailer hitch system 234.

As illustrated, said multiple tank acid mixing and delivery system 200 can be aligned around a central axis 236.

In one embodiment, said multiple tank acid mixing and delivery system 200 can comprise a new concept employing a mobile acid dock as a replacement for said prior art acid tank skid 100 in the fracking process.

In one embodiment, said mix tank 204 can comprise a 5000 gallon tank, said acid tank 206 can comprise a 6000 gallon tank, and both can be made of plastic. Said water line 222 can be steel. Said mix tank discharge valve 226 can comprise a ball valve. Said main connection manifold 230 can comprise MNPT connections. Said water manifold 228 can connect to said water line 222. Said support frame 202 can comprise beams. Said trailer wheels 232 and said trailer hitch system 234 can be connected to said support frame 202. Said mix tank 204 and said acid tank 206 can be secured to said support frame 202.

Said multiple tank acid mixing and delivery system 200 can incorporate two acid approved containers (said mix tank 204 and said acid tank 206) that are not reactive to HCL acid (said high concentration acid 110).

Said multiple tank acid mixing and delivery system 200 can keep said high concentration acid 110 in said acid tank 206 (the larger tank) and utilize said mix tank 204 (the smaller tank) to individually mix each stage of the frac job for the initial spearhead acid (said final acid mixture 106). said final acid mixture 106 can be premixed with the proper chemicals and will have the proper mixing of acid and water to bring the concentration to typically 15% HCL.

In one embodiment, fresh chemicals (said various chemicals 114) are introduced with each batch of mixed acid and is ready to be delivered to the pressure pumping company. One feature of said multiple tank acid mixing and delivery system 200 is the maintenance of said final acid mixture 106 within said mix tank 204 to avoid re-stirring throughout a fracking job.

Additional benefits of said multiple tank acid mixing and delivery system 200 can comprise avoiding corrosion with said mix tank 204 and said acid tank 206 due to their compassion of plastics and/or acid approved storage tanks; and improved/lowered maintenance costs; and improved portability.

Since said final acid mixture 106 can be created on the fly from its component parts, there is no need to create, or roll, a whole tank of acid for small projects. This approach further means that said high concentration acid 110 will not have time to settle in the bottom of a tank (such as that of said single liquid tank 102 in said prior art acid tank skid 100) over time.

In one embodiment, each batch of said final acid mixture 106 can include a fresh addition of said corrosion inhibitor 112 to protect the casing on the oil well.

Improvements of said mix tank 204 and said acid tank 206 over said single liquid tank 102 mean fewer spills and safer containment of said high concentration acid 110. This is appealing in all settings for the health of the environment but especially for use on Federal lands and delicate environments.

By delivering said multiple tank acid mixing and delivery system 200 on said trailer wheels 232 and said support frame 202, said multiple tank acid mixing and delivery system 200 avoids storage issues and adds the convenience of quick deliver, mixing and application on site.

Likewise, said multiple tank acid mixing and delivery system 200 can fit in the same space as a typical frac tank spread.

These efficiencies will be increased with less down time to mix acid.

FIG. 3 illustrates a perspective overview of said multiple tank acid mixing and delivery system 200.

In one embodiment, said mix tank 204 and said acid tank 206 can be secured to said support frame 202 with a plurality of tank bands 302 and a plurality of tank support brackets 304, as illustrated. In one embodiment, said plurality of tank bands 302 and said plurality of tank support brackets 304 can be secured to said support frame 202.

Said support frame 202 can comprise a front end 306, a rear end 308, a first side 310, a second side 312, and a central portion 318.

Said mix tank 204 can comprise a bulkhead fitting assembly 314 and a flow line ultrasonic level transmitter 316.

FIG. 4 illustrates perspective rear view of said multiple tank acid mixing and delivery system 200.

FIG. 5 illustrates a perspective overview of said mix tank 204.

As illustrated, said mix tank discharge valve 226, said water manifold 228 and said main connection manifold 230 can be attached to said front end 306 of said support frame 202. Said water line 222 can create a fluid connection from said water manifold 228 to said central portion 318 and/or said plumbing system 208.

Although not illustrated here, said water line 222 can connect to said water manifold 228 at a first end 500 and said plumbing system 208 at a second end 502.

FIG. 6 illustrates a perspective overview of said mix tank 204.

FIG. 7 illustrates an elevated side view of said mix tank 204 with a cutaway on said support frame 202.

In one embodiment, said multiple tank acid mixing and delivery system 200 can comprise a mix tank bypass line 700 in fluid connection between a mix tank inlet 702 and a mix tank outlet 704. In one embodiment, said mix tank bypass line 700 can be installed below said mix tank 204 and within said support frame 202.

In one embodiment, a portion of a fluid from said plumbing system 208 can be directed into said mix tank bypass line 700 and said mix tank inlet 702.

FIG. 8 illustrates a perspective overview of said central portion 318 of said multiple tank acid mixing and delivery system 200 with said mix tank 204 and said plumbing system 208.

In one embodiment, said mix tank inlet 702 can be connected to an acid drain spool 800.

Said multiple tank acid mixing and delivery system 200 can further comprise a discharge spool 802 and a mix tank discharge spool hose 804.

One objective of said plumbing system 208 in conjunction with said control system 210 is to monitor and control a chemical mixture of said final acid mixture 106 to be delivered from said multiple tank acid mixing and delivery system 200. One means of doing so is to regulate input of said water 108, said high concentration acid 110, said corrosion inhibitor 112 and said various chemicals 114 coming from said mix tank 204, said acid tank 206, said cone tank 212 and said chem tote input 214 to achieve a desired composition of said final acid mixture 106.

FIGS. 9A, and 9B illustrate an elevated top view and detailed view of said multiple tank acid mixing and delivery system 200 without said mix tank 204 and said acid tank 206.

In one embodiment, said multiple tank acid mixing and delivery system 200 can further comprise a power supply 900 connected to one or more components such as said control system 210 and said motor control station 224.

In one embodiment, said plumbing system 208 can comprise a water input line 902, an additives input line 904, said first pump 220, and a fluid output line 906. In one embodiment, said additives input line 904 can receive fluids from said acid tank 206, said cone tank 212 and/or said chem tote input 214.

FIG. 10 illustrates an elevated side view of said acid tank 206.

In one embodiment, said acid tank 206 can comprise an inlet 1000, and a fluid acid inlet line 1002. Said fluid acid inlet line 1002 can also be referred to as the acid skid load line.

FIG. 11 illustrates a perspective overview of said rear end 308 of said support frame 202.

As discussed, said plumbing system 208 can comprise said additives input line 904, this can further be divided up into a chem tote fluid input 1100 from a chem tote fluid line 1102, and an acid inlet line 1104.

A portion of fluids received in said chem tote fluid line 1102 can receive further additives from said cone tank 212, such—for example—as said corrosion inhibitor 112.

In one embodiment, said chem tote input 214 can comprise multiple inlets each with valves, as illustrated. Accordingly, said chem tote input 214 can receive multiple inputs.

FIGS. 12A, and 12B illustrate a perspective overview and lower side view of said multiple tank acid mixing and delivery system 200.

A call out A 1200 is shown in these figures and displayed in detail below.

FIG. 13 illustrates a perspective detailed view of said call out A 1200.

Said motor control station 224 can comprise or be attached to said control system 210, which is invoked in this specification as a software or hardware programmable system for monitoring and ensuring a proper mixture of said final acid mixture 106. Said motor control station 224 with said control system 210 can control valves attached to a portion of or all of the fluid lines in said multiple tank acid mixing and delivery system 200. Further said multiple tank acid mixing and delivery system 200 can comprises sensors and meters to monitor the status of and fluid movement within said multiple tank acid mixing and delivery system 200. Likewise, said first pump 220 can be controlled by said control system 210 and/or said motor control station 224.

In one embodiment, said support frame 202 can comprise a cord management system 1300 such as a spool wherein, a power or data line 1302 can connect said power supply 900 and said control system 210 to components of power sources outside of said multiple tank acid mixing and delivery system 200.

These parts are introduced in this specification and summarized here for quick reference:
said prior art acid tank skid 100,
said single liquid tank 102,
said manifold 104,
said final acid mixture 106,
said water 108,
said high concentration acid 110,
said corrosion inhibitor 112,
said various chemicals 114,
said fluid pump 116,
said multiple tank acid mixing and delivery system 200,
said support frame 202,
said mix tank 204,
said acid tank 206,
said plumbing system 208,
said control system 210,
said cone tank 212,
said chem tote input 214,
said chemical tote platform 216,
said acid fill line 218,
said first pump 220,
said water line 222,
said motor control station 224,
said mix tank discharge valve 226,
said water manifold 228,
said main connection manifold 230,
said trailer wheels 232,
said trailer hitch system 234,
said central axis 236,
said plurality of tank bands 302,
said plurality of tank support brackets 304,
said front end 306,
said rear end 308,
said first side 310,
said second side 312,
said bulkhead fitting assembly 314,
said flow line ultrasonic level transmitter 316,
said central portion 318,
said first end 500,
said second end 502,
said mix tank bypass line 700,
said mix tank inlet 702,
said mix tank outlet 704,
said acid drain spool 800,
said discharge spool 802,
said mix tank discharge spool hose 804,
said power supply 900,
said water input line 902,
said additives input line 904,
said fluid output line 906,
said inlet 1000,
said fluid acid inlet line 1002,
said chem tote fluid input 1100,
said chem tote fluid line 1102,
said acid inlet line 1104,
said call out A 1200,
said cord management system 1300, and
said power or data line 1302.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A multiple tank acid mixing and delivery system for receiving and managing a plurality of fluids and mixing a final acid mixture for use in hydraulic fracturing process, wherein:
said multiple tank acid mixing and delivery system comprises a support frame, a mix tank, an acid tank, a plumbing system, a control system, and a water manifold, a main connection manifold.

2. The multiple tank acid mixing and delivery system of claim 1, wherein:
said multiple tank acid mixing and delivery system is configured to incorporate two acid approved containers (said mix tank and said acid tank) that are not reactive to HCL acid (a high concentration acid.

3. The multiple tank acid mixing and delivery system of claim 2, wherein:
said multiple tank acid mixing and delivery system is configured to keep said high concentration acid in said acid tank (the larger tank) and utilize said mix tank (the smaller tank) to individually mix each stage of the frac job for the initial spearhead acid (said final acid mixture); and
said final acid mixture is premixed with the proper chemicals and will have the proper mixing of acid and water to bring the concentration to typically 15% HCL.

4. The multiple tank acid mixing and delivery system of claim 3, wherein:
fresh chemicals (a various chemicals) are introduced with each batch of mixed acid and is ready to be delivered to the pressure pumping company; and
One feature of said multiple tank acid mixing and delivery system is the maintenance of said final acid mixture within said mix tank to avoid re-stirring throughout a fracking job.

5. The multiple tank acid mixing and delivery system of claim 4, wherein:
said mix tank and said acid tank is secured to said support frame with a plurality of tank bands and a plurality of tank support brackets, as illustrated; and
said plurality of tank bands and said plurality of tank support brackets is secured to said support frame.

6. The multiple tank acid mixing and delivery system of claim 5, wherein:
said support frame comprises a front end, a rear end, a first side, a second side, and a central portion.

7. The multiple tank acid mixing and delivery system of claim 6, wherein:
a water line is configured to connect to said water manifold at a first end and said plumbing system at a second end.

8. The multiple tank acid mixing and delivery system of claim 7, wherein:
said multiple tank acid mixing and delivery system comprises a mix tank bypass line in fluid connection between a mix tank inlet and a mix tank outlet;
said mix tank bypass line is installed below said mix tank and within said support frame; and
a portion of a fluid from said plumbing system is directed into said mix tank bypass line and said mix tank inlet.

9. The multiple tank acid mixing and delivery system of claim 8, wherein:
One objective of said plumbing system in conjunction with said control system is to monitor and control a chemical mixture of said final acid mixture to be delivered from said multiple tank acid mixing and delivery system; and
One means of doing so is to regulate input of a water, said high concentration acid, a corrosion inhibitor and said various chemicals coming from said mix tank, said acid tank, a cone tank and a chem tote input to achieve a desired composition of said final acid mixture.

10. The multiple tank acid mixing and delivery system of claim 9, wherein:
said multiple tank acid mixing and delivery system is configured to further comprise a power supply connected to one or more components such as said control system and a motor control station.

11. The multiple tank acid mixing and delivery system of claim 10, wherein:
said acid tank comprises an inlet, and a fluid acid inlet line.

12. The multiple tank acid mixing and delivery system of claim 11, wherein:
said plumbing system comprises an additives input line, this is configured to further be divided up into a chem tote fluid input from a chem tote fluid line, and an acid inlet line.

13. The multiple tank acid mixing and delivery system of claim 12, wherein:
said motor control station comprises or be attached to said control system, which is invoked in this specification as a software or hardware programmable system for monitoring and ensuring a proper mixture of said final acid mixture;
said motor control station with said control system is configured to control valves attached to a portion of or all of the fluid lines in said multiple tank acid mixing and delivery system; and
said multiple tank acid mixing and delivery system comprises sensors and meters to monitor the status of and fluid movement within said multiple tank acid mixing and delivery system.

14. The multiple tank acid mixing and delivery system of claim 13, wherein:
a first pump is controlled by said control system or said motor control station.
